(19) United States
(12) Patent Application Publication
(10) Pub. No.: US 2016/0043500 A1
(43) Pub. Date: Feb. 11, 2016

(54) CONNECTOR

(71) Applicant: YAZAKI CORPORATION, Tokyo (JP)

(72) Inventors: Shigeo MORI, Shizuoka (JP); Masayuki KATAOKA, Shizuoka (JP); Fuminori SUGIYAMA, Shizuoka (JP)

(21) Appl. No.: 14/920,964

(22) Filed: Oct. 23, 2015

Related U.S. Application Data
(63) Continuation of application No. PCT/JP2014/061061, filed on Apr. 18, 2014.

(30) Foreign Application Priority Data
Apr. 30, 2013 (JP) 2013-094954

(51) Int. Cl. H01R 13/52

(52) U.S. Cl. CPC H01R 13/5219

(57) ABSTRACT

A connector includes an outer hard housing entirely molded from a hard material and including a wire insertion cylindrical body into which terminal fittings and end portions of electric wires are inserted, and an inner soft housing molded from a soft material and integrated with the terminal fittings and the end portions of the electric wires in the wire insertion cylindrical body. The wire insertion cylindrical body is provided with inner soft housing penetrating portions. The inner soft housing is provided with an outside exposed portion exposed to the outside through the inner soft housing penetrating portions. The outside exposed portion serves as a seal lip portion for sealing a gap between the connector and a mating connector.

### CROSS REFERENCE TO RELATED APPLICATIONS

This application is a continuation of International Application No. PCT/JP2014/061061, filed Apr. 18, 2014, and based upon and claims the benefit of priority from Japanese Patent Application No. 2013-094954, filed Apr. 30, 2013, the entire contents of all of which are incorporated herein by reference.

### TECHNICAL FIELD

The present application relates to a connector.

### BACKGROUND ART

A high-voltage connector directly attached to an apparatus such as an inverter used for an electric vehicle is required to have various functions such as a conductive function, an insulating function, a waterproof function, and an electromagnetic shielding function. Such a connector is composed of assembled components having different functions. JP 2003-297472 A (PTL 1) describes a connector having the functions described above.

The conventional connector described in PTL 1 has a configuration in which an end portion of an electric wire is connected with a terminal fitting, the end portion of the electric wire is housed in a housing, and the housing is inserted into a shield shell so as to have a conductive function, an insulating function, and an electromagnetic shielding function. In order to further ensure a waterproof function, a seal ring is placed between the end portion of the electric wire and the housing, an 0 ring is placed between the terminal fitting and the housing, and a unit packing is placed between the housing and an apparatus. In addition, in order to ensure a holding function to fix the electric wire to the housing and fix the seal ring to the housing, a rear holder is attached to the rear side of the housing.

### SUMMARY

Such a connector required to have various functions such as a conductive function, an insulating function, a waterproof function, an electromagnetic shielding function, and further a component-holding function inevitably includes many components corresponding to the number of functions required. Thus, the process of assembling the connector is complicated and the number of assembling steps increases. Further, a space is necessary per component having each individual function to assemble the connector, which restricts a reduction in size of the connector.

An object of the present application is to provide a connector in which the number of components is reduced, an assembling process is simplified, and a space for each component is saved.

A connector according to an aspect of the present application includes: an electric wire of which an end portion is connected with a terminal fitting; and a housing to be fitted to a mating connector and housing the terminal fitting connected to the end portion with the terminal fitting exposed to an outside. The housing includes: an outer hard housing entirely molded from a hard material and including a wire insertion cylindrical body into which the terminal fitting and the end portion of the electric wire are inserted; and an inner soft housing molded from a soft material and integrated with the terminal fitting and the end portion of the electric wire in the wire insertion cylindrical body. The wire insertion cylindrical body is provided with an inner soft housing penetrating portion. The inner soft housing includes an outside exposed portion exposed to the outside through the inner soft housing penetrating portion. The outside exposed portion serves as a seal lip portion for sealing a gap between the connector and the mating connector.

The wire insertion cylindrical body may include a body portion housing the terminal fitting and the end portion of the electric wire, a fitting hood portion provided on one side of the body portion and fitted to the mating connector, and a wire leading pipe provided on another side of the body portion and leading the electric wire out thereof, and the inner soft housing may include an inner housing portion integrated with the terminal fitting and the end portion of the electric wire in the wire insertion cylindrical body of the outer hard housing.

The inner soft housing may be integrated with a plurality of terminal fittings and a plurality of end portions of electric wires.

In the connector according to the aspect of the present application, the inner soft housing molded from a soft material is integrated with the terminal fitting and the end portion of the electric wire in the wire insertion cylindrical body of the outer hard housing so as to ensure a waterproof function to protect the terminal fitting and the end portion of the electric wire against water and a holding function to hold the terminal fitting and the end portion of the electric wire. Since the connector according to the aspect of the present application includes the inner soft housing having the function to insulate the respective components, the component-holding function and the waterproof function, the number of the components required for the connector to ensure the necessary functions can be reduced.

Since the number of the components can be reduced, the process of assembling the connector is simplified to decrease the assembling steps and also save the space for the respective components so as to reduce the size of the connector accordingly.

The inner soft housing is provided with the outside exposed portion exposed to the outside through the inner soft housing penetrating portion of the outer hard housing so as to reliably protect the gap between the outer hard housing and the mating connector against water.

Further, the outside exposed portion serves as a seal lip portion for sealing the gap between the connector and the mating connector so as to tightly adhere to the mating connector and thus reliably protect the gap between the connector and the mating connector against water.

When the inner soft housing includes the inner housing portion integrated with the terminal fitting and the end portion of the electric wire in the wire insertion cylindrical body of the outer hard housing, holding and waterproof performance with respect to the terminal fitting and the end portion of the electric wire can reliably be ensured.

The inner soft housing can be integrated with a plurality of end portions of electric wires and a plurality of terminal fittings.

### BRIEF DESCRIPTION OF DRAWINGS

FIG. 1 is a perspective view illustrating an entire connector according to an embodiment.

FIG. 2 is a cross-sectional view illustrating the inside of the connector according to the embodiment.

FIG. 3 is a perspective view illustrating an external appearance of an outer hard housing of the connector according to the embodiment.

FIG. 4 is a perspective view illustrating electric wires with terminal fittings connected thereto prepared for attachment to the connector.

FIG. 5A is a perspective view illustrating a state where the electric wires are inserted into the outer hard housing, and FIG. 5B is a perspective view illustrating the interior state of FIG. 5A.

FIG. 6A is a perspective view illustrating a state where an inner soft housing is integrated with the outer hard housing, and FIG. 6B is a perspective view illustrating the interior state of FIG. 6A.

### DESCRIPTION OF EMBODIMENTS

An embodiment of the present application will be explained with reference to the drawings.

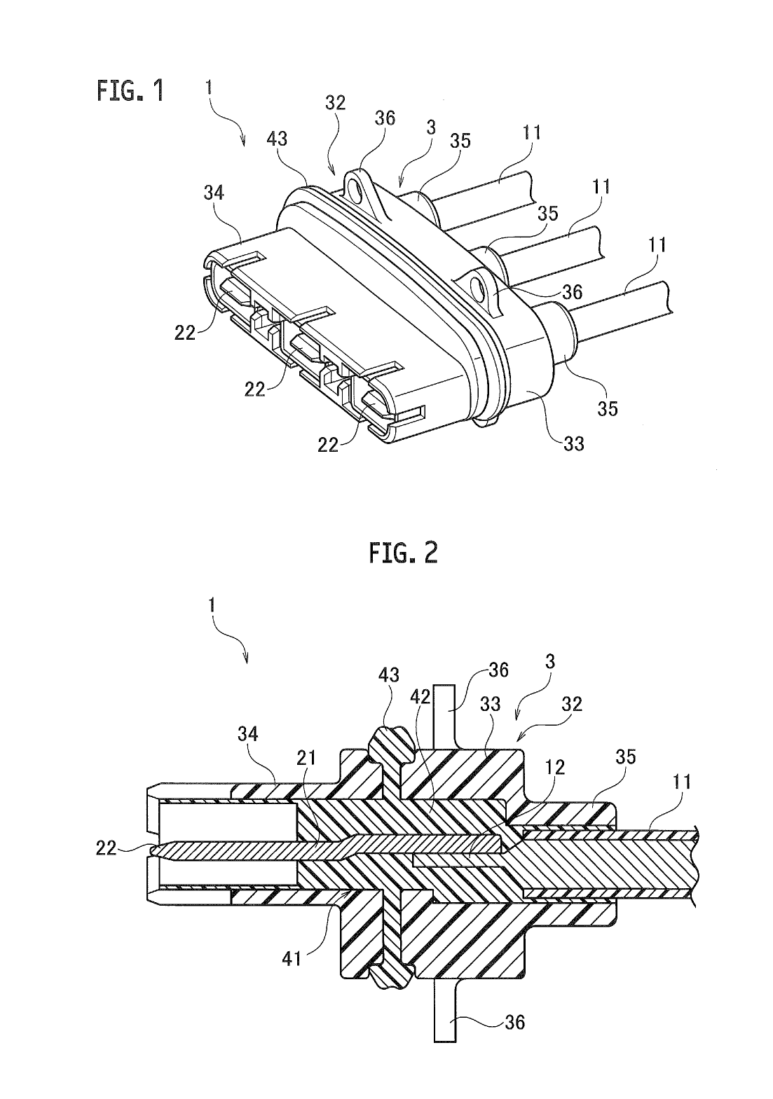

As illustrated in FIGS. 1 and 2, a connector 1 according to the embodiment includes electric wires 11 of which end portions 12 are connected with corresponding terminal fittings 21, and a housing 3 in which the terminal fittings 21 and the end portions 12 of the electric wires 11 are housed. The housing 3 houses the terminal fittings 21 and the end portions 12 of the electric wires 11 in a state where tip portions 22 of the terminal fittings 21 are exposed to the outside of the housing 3. The housing 3 is fitted into a mating housing (not illustrated) so as to be coupled together.

The electric wires 11 used are shield wires. As illustrated in FIG. 4, the end portion 12 of each of the electric wires 11 is connected with the terminal fitting 21. Each of the electric wires 11 has a configuration in which a conductor is covered with an inner insulating layer, the inner insulating layer is covered with a shield layer formed of a braided wire, and the shield layer is covered with an outer insulating layer. The conductor is exposed at the end portion 12, and an exposed portion 13 of the conductor is connected to the terminal fitting 21. Although a plurality of (three) electric wires 11 are attached to the connector 1 in the embodiment, the connector 1 may include a single electric wire 11.

Each of the terminal fittings 21 used is a plate-like terminal. Each of the terminal fittings 21 is a component for a conductive function. The tip portion 22 of each of the terminal fittings 21 is exposed to the outside of the housing 3, and the exposed tip portions 22 are connected to terminals of a mating connector.

The housing 3 includes an outer hard housing 31 located on the outside, and an inner soft housing 41 located inside the outer hard housing 31.

The outer hard housing 31 serves as an outer shell of the connector 1 and includes a wire insertion cylindrical body 32 into which the terminal fittings 21 and the end portions 12 of the electric wires 11 are inserted. The wire insertion cylindrical body 32 includes a body portion 33, a fitting hood portion 34, and wire leading pipes 35, which are all integrated together.

The body portion 33 houses the terminal fittings 21 and the end portions 12 of the electric wires 11 and holds the inner soft housing 41 in the inside thereof. The body portion 33 has a greater thickness than the fitting hood portion 34 and the wire leading pipes 35 in order to hold the inner soft housing 41 therein. The body portion 33 is provided with fixing flange pieces 36 on upper and lower outer walls of the body portion 33 so as to be fixed to the mating connector.

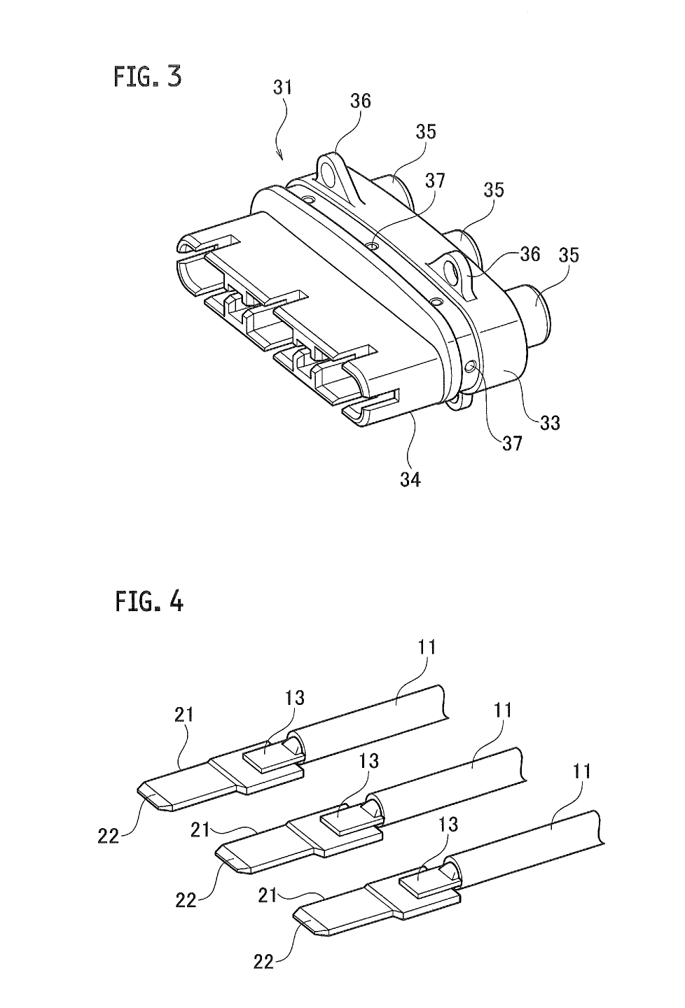

The body portion 33 is provided with inner soft housing penetrating portions 37. As illustrated in FIG. 3, the inner soft housing penetrating portions 37 are through-holes located in front of the fixing flange pieces 36 and pierced in the body portion 33 in the thickness direction. The multiple inner soft housing penetrating portions 37 are formed at predetermined intervals along the circumference of the body portion 33. The inner soft housing penetrating portions 37 serve as passages through which a resin material of the inner soft housing 41 flows to the outside of the body portion 33 when the inner soft housing 41 is molded in a metal die.

The fitting hood portion 34 is integrated with one side (the tip side) of the body portion 33. The fitting hood portion 34 is fitted into the mating connector so as to be coupled together. The tip portions 22 of the terminal fittings 21 are led to the inside of the fitting hood portion 34. Accordingly, the terminal fittings 21 can be connected to the terminals of the mating connector inside the fitting hood portion 34.

The wire leading pipes 35 are integrated with the other side (the rear end side) of the body portion 33. The electric wires 11 elongated from the end portions 12 are exposed to the outside of the wire leading pipes 35.

The wire insertion cylindrical body 32 (the body portion 33) of the outer hard housing 31 is provided with the inner soft housing 41 inside thereof. The outer hard housing 31 has a function to hold the inner soft housing 41 therein. Thus, the outer hard housing 31 is required to have hardness suitable to hold the inner soft housing 31. The outer hard housing 31 is formed of an insulating resin material such as polybutylene terephthalate (PBT) or syndiotactic polystyrene (SPS) which is a hard material generally used for a connector housing.

In the connector 1 according to the embodiment, metal powder such as metal filler may be mixed into the outer hard housing 31. The outer hard housing 31 mixed with the metal filler can ensure an electromagnetic shielding function.

The inner soft housing 31 is formed in a manner such that the wire insertion cylindrical body 32 of the outer hard housing 31 is filled with a soft material having an insulation property so as to be integrated with the terminal fittings 21 and the end portions 12 of the electric wires 11 inside the wire insertion cylindrical body 32. The inner soft housing 31 includes an inner housing portion 42 provided in the body portion 33 of the wire insertion cylindrical body 32, and an outside exposed portion 43 extending to the outside from the inner housing portion 42.

The inner housing portion 42 fills the body portion 33 of the outer hard housing 31 in which the terminal fittings 21 and the end portions 12 of the electric wires 11 are placed, and further fills the inside of the fitting hood portion 34 and the wire leading pipes 35.

The inner housing portion 42 adheres to the terminal fittings 21 and the end portions 12 of the electric wires 11 inside the body portion 33 of the outer hard housing 31 so as to ensure a waterproof function to protect the terminal fittings 21 and the end portions 12 of the electric wires 11 against water due to the adhesion thereto. The inner housing portion 42 further has a function to hold the terminal fittings 21 and the end portions 12 of the electric wires 11 by the adhesion and pressing force due to the hardness thereof. The inner housing portion 42 has a waterproof function to protect the terminal fittings 21 against water due to the adhesion to the terminal fittings 21 inside the fitting hood portion 34 and has a function to hold the terminal fittings 21 by the adhesion and the pressing force due to the hardness thereof. The inner housing portion 42 has a waterproof function to protect the electric wires 11 against water due to the adhesion to the electric wires 11 inside the wire leading pipes 35 and has a function to hold the electric wires 11 by the adhesion and the pressing force due to the hardness thereof.

The outside exposed portion 43 is exposed to the outside of the body portion 33 of the outer hard housing 31 through the inner soft housing penetrating portions 37 of the outer hard housing 31. The outside exposed portion 43 is formed in such a manner as to flow through the inner soft housing penetrating portions 37 to the outside of the body portion 33 so as to be exposed along the circumference of the body portion 33 of the outer hard housing 31.

The outside exposed portion 43 exposed along the circumference of the body portion 33 serves as a seal lip portion tightly adhering to an inner wall surface of an attachment hole of the mating connector when the fitting hood portion 34 is fitted into the mating connector. The outside exposed portion 43 is pressed against the mating connector by the tight adhesion thereto. The outside exposed portion 43 has a waterproof function to protect the gap between the outer hard housing 31 of the connector 1 and the mating connector against water by reaction force due to the applied pressure.

As described above, the inner soft housing 41 not only has an insulating function that a common connector housing inherently has but also has a waterproof function to protect the terminal fittings 21 and the electric wires 11 and the boundary between the outer hard housing 31 and the mating connector against water due to the function to hold the terminal fittings 21 and the end portions 12 of the electric wires 11 by the adhesion to the outer hard housing 31 and due to appropriate reaction force (elastic force). In view of this, an acrylic adhesive or an elastomeric resin material is used as a soft material. The elastomeric resin material used is obtained in a manner such that polyester elastomer, styrene elastomer, olefin elastomer, polyurethane elastomer, polyamide elastomer, or nylon elastomer is used as a base, and an adhesive with a hydroxyl group (OH group) having a hydrogen bond to metal is mixed to the base elastomer.

Next, the process of assembling the connector 1 according to the embodiment is explained with reference to FIGS. 3 to 8.

FIG. 3 illustrates the outer hard housing 31 formed in a manner such that a resin material is poured into a metal die. The outer hard housing 31 integrally includes the body portion 33, the fitting hood portion 34 on one side of the body portion 33, and the plural wire leading pipes 35. The body portion 33 is provided with the fixing flange pieces 36 projecting from and integrated with the upper and lower outer walls of the body portion 33. The plurality of inner soft housing penetrating portions 37 serving as through-holes is formed along the circumference of the body portion 33 at predetermined intervals.

FIG. 4 illustrates the electric wires 11 to be inserted into the outer hard housing 31 illustrated in FIG. 3. The electric wires 11 are inserted into the wire insertion cylindrical body 32 through the respective wire leading pipes 35 in the state where the terminal fittings 21 are connected to the end portions 12.

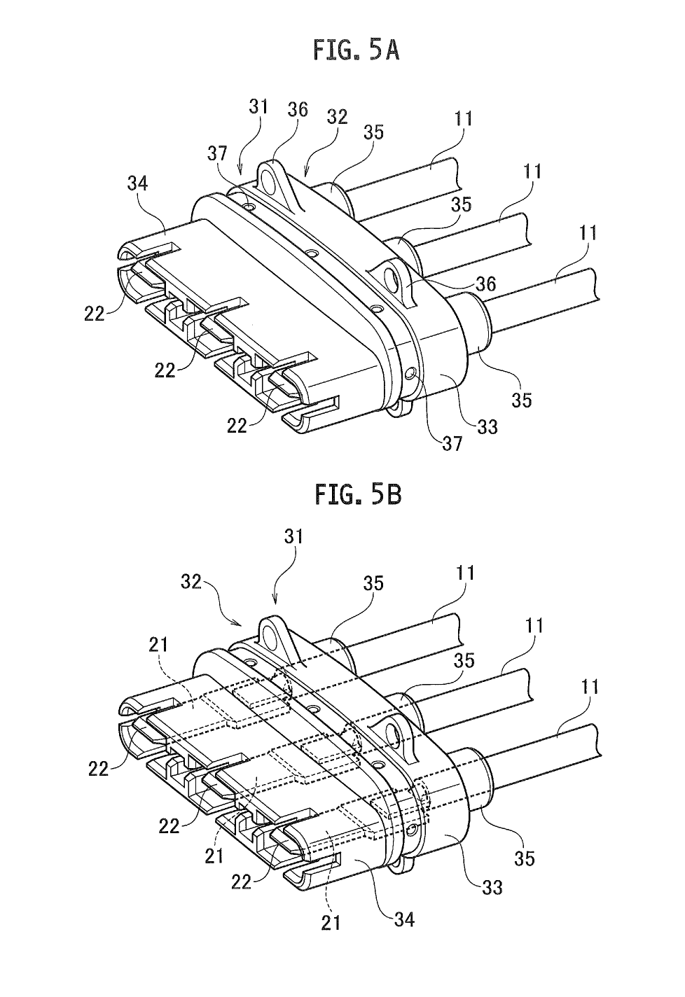

FIG. 5A is a view illustrating a state where the electric wires 11 to which the terminal fittings 21 are connected are inserted into the outer hard housing 31, and FIG. 5B is a perspective view illustrating the interior state thereof. The electric wires 11 are inserted into the wire insertion cylindrical body 32 of the outer hard housing 31 through the respective wire leading pipes 35. As a result, the tip portions 22 of the terminal fittings 21 connected to the end portions 12 of the electric wires 11 are led to the inside of the fitting hood portion 34.

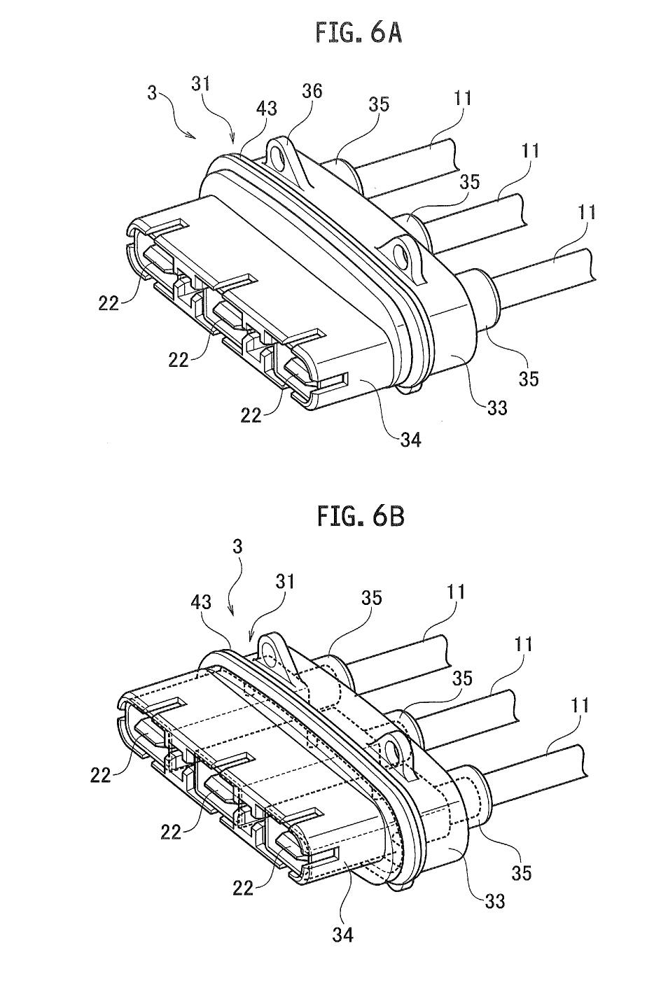

The above-described elastomer-based soft material is poured into a metal die and subjected to molding in a state where the outer hard housing 31 with the attached state illustrated in FIG. 5 is inserted in the metal die. FIG. 6A is a view illustrating a state where the soft material is molded, and FIG. 6B is a perspective view illustrating the interior state thereof. The resin material is poured into the metal die so that the inner housing portion 42 is formed in the gap between the terminal fittings 21 and the end portions 12 of the electric wires 11 and the outer hard housing 31, as illustrated in FIGS. 1 and 2. At the same time, the soft resin material flows to the outside through the inner soft housing penetrating portions 37, so that the outside exposed portion 43 is formed along the circumference of the body portion 33 of the outer hard housing 31.

In the connector 1 according to the embodiment described above, the terminal fittings 21 have the conductive function, and the inner soft housing 41 has the insulating function. In addition, the inner soft housing 41 molded from the soft material is integrated with the terminal fittings 21 and the end portions 12 of the electric wires 11 so as to have the waterproof function to protect the terminal fittings 21 and the end portions 12 of the electric wires 11 against water, and the function to hold the terminal fittings 21 and the end portions 12 of the electric wires 11 in the body portion 33. The inner soft housing 41 has the waterproof function to protect the terminal fittings 21 against water, and hold the terminal fittings 21 inside the fitting hood portion 34. The inner soft housing 41 has the waterproof function to protect the electrical wires 11 against water and hold the electrical wires 11 inside the wire leading pipes 35. In addition, the outside exposed portion 43 of the inner soft housing 41 has the waterproof function to protect the gap between the outer hard housing 31 and the mating housing against water.

Since the inner soft housing 41 has the function to insulate the respective components, the component-holding function and the waterproof function, the number of the components required for the connector 1 to ensure the necessary functions can be reduced. The decrease in the number of the components can simplify the process of assembling the connector 1 to decrease the assembling steps. The decrease in the number of the components can further save the space for the respective components so as to reduce the size of the connector 1.

Further, in the connector 1 according to the embodiment, the outer hard housing 31 is mixed with the metal powder so as to have the electromagnetic shielding function. Thus, the connector 1 according to the embodiment is not required to have a shield shell used for electromagnetic shielding so as to further reduce the number of the components.

In the connector 1 according to the embodiment, the inner soft housing 41 includes the inner housing portion 42 integrated with the terminal fittings 21 and the end portions 12 of the electric wires 11 inside the wire insertion cylindrical body 32 of the outer hard housing 31. Thus, the connector 1 according to the embodiment can reliably ensure the holding and waterproof function with respect to the terminal fittings 21 and the end portions 12 of the electric wires 11.

In the connector 1 according to the embodiment, the inner soft housing 41 is provided with the outside exposed portion 43 exposed to the outside through the inner soft housing penetrating portions 37 of the outer hard housing 31. Thus, the connector 1 according to the embodiment can reliably protect the gap between the outer hard housing 31 and the mating connector against water.

In the connector 1 according to the embodiment, the outside exposed portion 43 serves as the seal lip portion for sealing the gap between the connector 1 and the mating connector. Thus, the connector 1 according to the embodiment can tightly adhere to the mating connector so as to reliably protect the gap therebetween against water.

What is claimed is:

1. A connector, comprising:
an electric wire of which an end portion is connected with a terminal fitting; and
a housing to be fitted to a mating connector, and housing the terminal fitting connected to the end portion with the terminal fitting exposed to an outside,
the housing comprising:
an outer hard housing entirely molded from a hard material, and comprising a wire insertion cylindrical body into which the terminal fitting and the end portion of the electric wire are inserted; and
an inner soft housing molded from a soft material and integrated with the terminal fitting and the end portion of the electric wire in the wire insertion cylindrical body,
wherein the wire insertion cylindrical body is provided with an inner soft housing penetrating portion,
the inner soft housing comprises an outside exposed portion exposed to the outside through the inner soft housing penetrating portion, and
the outside exposed portion serves as a seal lip portion for sealing a gap between the connector and the mating connector.

2. The connector according to claim 1, wherein:
the wire insertion cylindrical body comprises
a body portion housing the terminal fitting and the end portion of the electric wire,
a fitting hood portion provided on one side of the body portion, and fitted to the mating connector, and
a wire leading pipe provided on another side of the body portion, and leading the electric wire out thereof; and
the inner soft housing comprises an inner housing portion integrated with the terminal fitting and the end portion of the electric wire in the wire insertion cylindrical body of the outer hard housing.

3. The connector according to claim 1, wherein the inner soft housing is integrated with a plurality of terminal fittings, and a plurality of end portions of electric wires.
